(19) United States
(12) Patent Application Publication
(10) Pub. No.: US 2022/0406495 A1
(43) Pub. Date: Dec. 22, 2022

(54) R-FE-B SINTERED MAGNET

(71) Applicant: Shin-Etsu Chemical Co., Ltd., tokyo (JP)

(72) Inventors: Akihiro Yoshinari, Echizen-shi (JP); Kazuaki Sakaki, Echizen-shi (JP)

(73) Assignee: Shin-Etsu Chemical Co., Ltd., Tokyo (JP)

(21) Appl. No.: 17/772,318

(22) PCT Filed: Nov. 5, 2020
(86) PCT No.: PCT/JP2020/041339

§ 371 Date: Apr. 27, 2022

(30) Foreign Application Priority Data
Nov. 11, 2019 (JP) 2019-203966

(51) Int. Cl. H01F 1/057

(52) U.S. Cl. CPC H01F 1/057

(57) ABSTRACT

The purpose of the present invention is to achieve both high residual flux density and high coercivity, which are conventionally mutually exclusive characteristics, in an R—Fe—B sintered magnet. The present invention provides an R—Fe—B sintered magnet characterized by having a composition which contains R (R is one or more elements selected from among the rare-earth elements but must be Nd), B. X (X is one or more elements selected from among Ti, Zr, Hf, Nb, V, and Ta), and C, with the remainder comprising Fe, O, other arbitrary elements, and unavoidable impurities. The R—Fe—B sintered magnet is also characterized by satisfying relational expression (1), where [B], [C], [X], and [O] are the atomic percentages of B, C, X, and O, respectively.

0.86×([B]+[C]−2×[X])−4.9<[O]<0.86×([B]+[C]−2×[X])−4.6 (1).

### TECHNICAL FIELD

This invention relates to a R—Fe—B-type rate-earth sintered magnet in which the residual flux density has been increased while suppressing a decrease in coercivity.

### BACKGROUND ART

The range of application and production volume of R—Fe—B-type sintered magnets (sometimes referred to below as “Nd magnets”), as functional materials that are necessary and indispensable to energy savings and higher functionality, is increasing, year by year. Such magnets are used in, for example, drive motors and power steering motors for hybrid cars and electric cars, in AC compressor motors and in voice coil motors (VCM) for hard disk drives. The high residual flux density (abbreviated below as “Br”) of R—Fe—B-type sintered magnets is a major advantage in these various uses, but a further increase in Br is desired in order to, for example, further reduce the size of the motors.

Hitherto known methods for increasing the Br of R—Fe—B-type sintered magnets include that of lowering the R content so as to increase the proportion of the R₂Fe₁₄B phase in the sintered magnet, and that of lowering the amount of added elements which enter into solid solution with the R₂Fe₁₄B phase and decrease the Br.

However, it is known that lowering the amount of R and other added elements ends so up reducing the coercivity (abbreviated below as “H_{cJ}”) that has a close bearing on the heat resistance of a sintered magnet. In particular, when the amount of R elements is reduced, in the R—Fe—B-type sintered magnet sintering step where densification accompanied by liquid phase formation arises, the sinterability decreases and there is also a risk of abnormal grain growth occurring. Hence, to obtain R—Fe—B-type sintered magnets having higher properties, it is necessary to attain a high Br while suppressing a decrease in H_{cJ} from a reduction in the amount of R and other added elements. The addition of heavy rare-earth elements such as Dy and Tb in order to suppress a decrease in H_{cJ} or increase the H_{cJ} is commonly known. However, because the addition of these elements leads to a decrease in Br and also because, in terms of resources, such elements are scarce and expensive, techniques that relate to lowering the amount of Dy, Tb and other heavy rare-earth elements used have hitherto been disclosed.

For example, WO 2013/191276 A1 (Patent Document 1) discloses a sintered magnet in which, by making the boron (B) content lower than the stoichiometric composition, adding from 0.1 to 1.0 wt % of Ga and also adjusting the weight ratios of B, Nd, Pr, C and Ga such that the values for [B]/([Nd]+[Pr]) and ([Ga]+[C])/[B] satisfy specific relationships, a high H_{cJ} can be obtained even in compositions in which reduced amounts of heavy rare-earth elements such as Dy and Tb are used.

WO 2004/081954 A1 (Patent Document 2) discloses a sintered magnet having a higher Br that can be obtained by setting the B content to an approximately stoichiometric composition and thus suppressing the formation of an R_{1.1}Fe₄B₄ phase. Moreover, by including from 0.01 to 0.08 wt % of Ga, precipitation of a R₂Fe₁₇ phase which leads to a decrease in H_{cJ} when the amount of B is lower than the stoichiometric composition is suppressed, enabling a high Br and a high lid to both be achieved.

### PRIOR ART DOCUMENTS

### Patent Documents

Patent Document 1: WO 2013/191276 A1

Patent Document 2: WO 2004/081954 A1

### SUMMARY OF INVENTION

### Technical Problem

In the magnet disclosed in Patent Document 1, the amount of heavy rare-earth elements such as Dy and Tb used becomes correspondingly smaller with the addition of at least 0.1 wt % of Ga, enabling an increase in saturation magnetization of the R₂Fe₁₄B phase. Yet, with Ga addition, saturation magnetization of the R₂Fe₁₄B phase decreases, and so a sufficient increase in Br is not necessarily achieved.

In the art disclosed in Patent Document 2, although good magnetic properties are indeed obtained in the case of R—Fe—B-type sintered magnets having an O concentration of about 0.4 wt %, the description of the relationship between the oxygen concentration in the sintered magnet and the magnetic properties is inadequate. At oxygen concentrations lower than this, especially at 0.2 wt % or less, the behavior of these properties changes markedly and achieving both a high. Br and a high H_{cJ} is not always possible.

The present invention was arrived at in light of these problems, the object of the invention being to provide R—Fe—B-type sintered magnets which, by adjusting and optimizing the ratios in the amounts of the constituent elements therein, have a high Br and a stable H_{cJ}.

### Solution to Problem

In order to achieve this object, the inventors have conducted intensive investigations on R—Fe—B-type sintered magnets containing B, C, O and X (where X is one or more of Ti, Zr, Hf, Nb, V and Ta) in which they studied the elemental compositions of the magnets, inclusive of the C and O that are commonly regarded as impurities. As a result, they have found that by adjusting the B, C, O and X contents within given ranges, the magnets have a. high Br and that, within these ranges, a stable Ha can be obtained. This discovery ultimately led to the present invention.

Accordingly, this invention provides the following R—Fe—B-type sintered magnet.
[1]

An R—Fe—B sintered magnet having a composition consisting essentially of from 12.5 to 14.5 at % of R (where R is one or more element selected from the rare-earth elements. with Nd being essential), from 5.0 to 6.5 at % of B, from 0.02 to 0.5 at % of X (where X is one or more element selected from Ti, Zr, Hf, Nb, V and Ta) and from 0.1 to 1.6 at % of C, the balance being Fe, O and other, optional, elements and inadvertent impurities, wherein, letting the atomic percentages of B, C, X and O be respectively [B], [C], [X] and [O], the magnet satisfies the following relationship (1):

0.86×([B]+[C]−2×[X])−4.9<[O]<0.86×([B]+[C]−2×[X])−4.6 (1).
[2]

The R—Fe—B-type sintered magnet of [1], wherein the content of O is from 0.1 to 0.8 at %.
[3]

The R—Fe—B-type sintered magnet of [1] or [2], wherein the optional elements include from 0.1 to 3.5 at % of Co, from 0.05 to 0.5 at % of Cu, and more than 0 at % and up to 1.0 at % of Al.
[4]

The R—Fe—B-type sintered magnet of any of [1] to [3], wherein Zr is included as X.

[5]

The R—Fe—B-type sintered magnet of any of [1] to [4], wherein the optional elements include more than 0 at % and up to 0.1 at % of Ga.

### Advantageous Effects of Invention

The R—Fe—B-type sintered magnet of the invention, through adjustment and optimization of, within the constituent elements of the magnet composition, the ratios in the amounts of B, C, O and X (one or more of Ti, Zr, Hf, Nb, V and Ta), is able to achieve both a high Br and a high H_{cJ}, which have hitherto been mutually incompatible properties.

### BRIEF DESCRIPTION OF DRAWINGS

FIG. 1 is a graph showing the relationship between [B]+[C]−2×[X] and [O] in the magnets of Examples 1 to 5 and Comparative Examples 1 to 6.

### DESCRIPTION OF EMBODIMENTS

The R—Fe—B-type sintered magnet of the invention has, as noted above, a composition which consists essentially of from 12.5 to 14.5 at % of R (where R is one or more element to selected from the rare-earth elements, with Nd being essential), from 5.0 to 6.5 at % of B, from 0.02 to 0.5 at % of X (where X is one or more element selected from Ti, Zr, Hf, Nb, V and Ta), and from 0.1 to 1.6 at % of C, the balance being Fe, O and other, optional, elements and inadvertent impurities.

The constituent element R in the sintered magnet of the invention is, as noted above, one or more element selected from the rare-earth elements, with Nd being essential. The rare-earth elements other than Nd are preferably Pr, La, Ce, Gd, Dy, Tb and Ho, more preferably Pr, Dy and Tb, and most preferably Pr. The essential constituent Nd accounts for preferably at least 60 at %, and especially at least 70 at %, of the overall R.

The R content is, as noted above, from 12.5 to 14.5 at %, and is preferably from 12.8 to 14.0 at %. At an R content below 12.5 at %, α-Fe crystallization arises in the starting alloy; even with homogenization eliminating the α-Fe is difficult, resulting in large declines in the HcJ and squareness of R—Fe—B-type sintered magnets. Even in cases where the starting alloy is produced by strip casting in which α-Fe crystallization occurs with difficulty, given that α-Fe crystallization does occur, the H_{cJ} and the squareness of R—Fe—B-type sintered maples undergo large declines. In addition, because the amount of liquid phase consisting primarily of R constituents that has the role of promoting densification in the course of sintering decreases, densification of the R—Fe—B-type sintered magnet is inadequate. On the other hand, when the R content exceeds 14.5 at %, although there are no problems in production, the proportion of the R₂Fe₁₄B phase in the sintered magnet becomes lower, decreasing the Br.

As noted above, the sintered magnet of the invention contains from 5.0 to 6.5 wt % boron (B). The content is more preferably from 5.1 to 6.1 at %, and even more preferably from 5.2 to 5.9 at %. In this invention, the B content, together with the subsequently described C and X contents, is a factor that determines the range in the oxygen concentration required to obtain a stable H_{cJ}. At a B content below 5.0 at %, the proportion of the R₂Fe₁₄B phase that forms is low and the Br greatly decreases; along with this, an R₂Fe₁₇ phase forms, lowering the H_{cJ}. On the other hand, at a B content in excess of 6.5 at %, a B-rich phase forms and the ratio of R₂Fe₁₄B phase in the magnet decreases, leading to a decrease in Br.

The element X in the sintered magnet of the invention is, as noted above, one or more element selected from Ti, Zr, Hf, Nb, V and Ta. By including these elements, abnormal grain growth during sintering-can be suppressed-due to the X—B phase that forms. Although not particularly limited, it is preferable for Zr to be included as at least one of these X elements.

The content of X is, as noted above, from 0.02 to 0.5 at %, and is preferably from 0.05 to 0.3 at %, and more preferably from 0.07 to 0.2 at %. When the content of X is less than 0.02 at %, the effect of suppressing abnormal growth by crystal grains in the course of sintering cannot be obtained. On the other hand, when the content of X exceeds 0.5 at %, an X—B phase forms and so the amount of B available for R₂Fe₁₄B phase formation diminishes, which may lead to a lower Br on account of a decrease in the R₂Fe₁₄B phase ratio and, in turn, to a major decrease in H_{cJ} owing to formation of an R₂Fe₁₇ phase.

The carbon (C) content in the sintered magnet of the invention is, as noted above, from 0.1 to 1.6 at %, and is preferably from 0.2 to 1.0 at %. Because the carbon originates from, for example, the raw materials and lubricant that is added to increase orientation of the powder during pressing in a magnetic field, it is difficult to obtain an R—Fe—B-type sintered magnet having a carbon content below 0.1 at %. On the other hand, when the carbon content exceeds 1.6 at %, much R—C phase is present in the sintered magnet, resulting in a marked decrease in H_{cJ}.

The sintered magnet of the invention contains R, B and C in the predetermined amounts indicated above, with the balance being Fe, O, other, optional, elements and inadvertent impurities. Letting the atomic percentages of B, C, X and O be respectively [B], [C], [X] and [O], the content of O in the invention is in a range that satisfies the following relationship (1):

0.86×([B]+[C]−2×[X])−4.9<[O]<0.86×([B]+[C]−2×[X])−4.6 (1).

That is, in the composition of the inventive sintered magnet, although the range in the O content varies with the above contents [B], [C] and [X], given that an oxygen content of less than 0.1 at % may present difficulties in terms of Nd magnet production, the O content is preferably within the range of 0.1 to 0.8 at %, more preferably within the range of 0.2 to 0.7 at %, and also satisfies relationship (1) above. The O content is a critical element in this invention. When the O content is equal to or lower than the left side (0.86×([B]+[C]−2×[X])−4.9) of above relationship (1), the H_{cJ} decreases. In cases as well where the O content is equal to or higher than the right side (0.86×([B]+[C]−2×[X])−4.6) of relationship (1), the H_{cJ} decreases.

As noted above, in addition to the above-described elements R, B, X. C, Fe and O, the sintered magnet of the invention may include also optional elements such as Co, Cu, Al, Ga, and N.

The Co content, from the standpoint of obtaining higher Curie temperature and corrosion resistance-improving effects due to the inclusion of Co, is preferably at least 0.1 at %, and more preferably at least 0.5 at %. From the standpoint of stably obtaining a high H_{cJ}, the Co content is preferably not more than 3.5 at %, and more preferably not more than 2.0 at %.

The Cu content, from the standpoint of obtaining an optimal temperature range in post-sintering low-temperature heat treatment which is suitably carried out in order to ensure good productivity, is preferably at least 0.05 at %, and more preferably at least 0.1 at %. From the standpoint of obtaining a good sinterability and high magnetic properties (Br, H_{cJ}), the Cu content is preferably not more than 0.5 at %, and more preferably not more than 0.3 at %.

The Al content, from the standpoint of obtaining a sufficient H_{cJ}, is preferably more than 0 at %, and more preferably at least 0.05 at %. From the standpoint of obtaining a high Br, the Al content is preferably not more than 1.0 at %, and more preferably not more than 0.5 at %. In addition, from the same standpoint, the Ga content is preferably more than 0 at % and not more than 0.1 at %, and is more preferably from 0.05 to 0.1 at %. Also, the N content, from the standpoint of obtaining a good H_{cJ}, is preferably not more than 0.7 at %.

Aside from these elements, the inclusion in the inventive sintered magnet of, as inadvertent impurities, such elements as H, F, Mg, P, S, Cl, Ca, Mn and Ni is allowable up to a total amount of the inadvertent impurities of not more than 0.1 wt % based on the sum of the above-mentioned constituent elements of the magnet and these inadvertent impurities, although it is preferable for the amount of these inadvertent impurities to be low.

The sintered magnet of the invention, as noted above, has a composition which is adjusted such that the O content satisfies above relationship (1). That is, letting the atomic percentages of B, C, X and O be respectively [B], [C], [X] and [O], the sintered magnet satisfies the following relationship (1):

0.86×([B]+[C]−2×[X])−4.9<[O]<0.86×([B]+[C]−2×[X])−4.6 (1).

By satisfying this relationship, it is possible to achieve both a high Br and a stable H_{cJ}. The reason for this, although not entirely clear, is conjectured to be as follows. Some of the B in the R₂Fe₁₄B compound is known to be substitutable with C, but C generally forms an R—O—C phase, which is an impurity phase, at crystallization grain boundary triple junction and substantially does not contribute to formation of the main phase. On the other hand, when attempting to obtain a high Br by lowering the R content as in this invention, it is necessary to lower the content of the impurity O in order to promote liquid phase sintering. Under such low-oxygen content conditions, it is thought to be possible that the amount of R—O—C phase formation decreases and that, with this, some of the C readily forms R₂Fe₁₄C. Also, the X in the sintered magnet forms primarily XB₂ compounds, which suppress abnormal grain growth of crystal grains in the course of sintering and also have the effect of lowering the amount of R₂Fe₁₄B phase that forms due to B and C. That is, the amount of B and C atoms that actually contribute to formation of the R₂Fe₁₄B phase can be represented by ([B]+[C]−2×[X]). Hence, the inventors realized that the contents of B, C, X and O atoms play a part in formation of the R₂Fe₁₄B phase and, by optimizing the relationship between ([B]+[C]−2×[X]) and [O], achieved both a high Br and a high H_{cJ}. The content of O atoms can be adjusted in the pulverizing step in which the starting alloy is pulverized to obtain an alloy fine powder, as is done in the subsequently described Examples.

Next, a method for producing the R—Fe—B-type sintered magnet of the invention is described.

The steps carried out when producing the R—Fe—B-type sintered magnet of the invention are basically the same as those used in a conventional powder sintering method, and are not particularly limited. They generally include a melting step which melts the raw material to obtain a starting alloy, a pulverizing step which pulverizes the starting alloy having a predetermined composition so as to prepare an alloy fine powder, a pressing step which presses the alloy fine powder in an applied magnetic field to form a compact, and a heat treatment step which heat treats the compact to form a sintered body.

First, in the melting step, the metals or alloys serving as the sources of the various elements are weighed out so as to give the above-described predetermined composition in the invention, and this raw material is melted by, for example, high-frequency heating and then cooled to produce the starting alloy. Casting of the starting alloy is generally carried out using a melt casting process in which the molten alloy is cast into a flat mold or a book mold, or a strip casting method. Alternatively, it is also possible to employ in this invention a two-alloy process wherein an alloy close in composition to the R₂Fe₁₄₄B compound that serves as the main phase of the R—Fe—B-type alloy and an R-rich alloy that serves as a liquid phase aid at the sintering temperature are separately produced, following which these alloys are coarsely pulverized and then weighed out and mixed together. However, in the alloy close in composition to the main phase, depending on the cooling rate during casting and the alloy composition, an α-Fe phase tends to crystallize. Therefore, in order to make the microstructure uniform and eliminate the α-Fe phase, where necessary, it is preferable to carry out at least one hour of homogenizing treatment at between 700° C. and 1,200° C. in a vacuum or an argon atmosphere. In cases where the alloy close in composition to the main phase is produced by a strip casting process, homogenization can be omitted. As for production of the R-rich alloy that serves as the liquid phase aid, aside from the above casting method, use can also be made of a liquid quenching process.

The pulverizing step may a multi-stage step that includes, for example, a coarse pulverizing step and a fine pulverizing step. A jaw crusher, Braun mill, pin mill or hydrogen decrepitation, for example, may be used in the coarse pulverizing step. In the case of alloys produced by strip casting, a coarse powder that has been coarsely pulverized to a size of, for example, from 0.05 to 3 mm, especially from 0.05 to 1.5 mm, can generally be obtained by employing hydrogen decrepitation. In the fine pulverizing step, the coarse powder obtained in the coarse pulverizing step is finely pulverized to, for example, from is 0.2 to 30 μm, and especially from 0.5 to 20 μm, using a method such as jet milling. In either or both of the coarse pulverizing and fine pulverizing steps on the starting alloy, where necessary, the carbon content may be adjusted to the predetermined range by adding an additive such as a lubricant. The coarse pulverizing and fine pulverizing, steps on the starting alloy are preferably carried out in a gas atmosphere such as nitrogen gas or argon gas. The oxygen content may be adjusted to the predetermined range by controlling the oxygen concentration within the gas atmosphere.

In the pressing step, the alloy powder is compacted with a compression molding machine while applying a 400 to 1,600 kA/m magnetic field and orienting the powder in the direction of easy magnetization. The density of the compact is preferably set at this time to from 2.8 to 4.2 g/cm³. To ensure the strength of the compact and obtain a good handleability, it is preferable to set the density of the compact to at least 2.8 g/cm³. On the other hand, to obtain a suitable Br by ensuring good orientation of the particles during the application of pressure while achieving an adequate compact strength, it is preferable for the density of the compact to be set to not more than 4.2 g/cm³. In order to suppress oxidation of the alloy fine powder, it is preferable to carry out pressing in a gas atmosphere such as nitrogen gas or argon gas.

In the heat treatment step, the compact obtained in the pressing step is sintered in a non-oxidizing atmosphere such as a high vacuum or argon gas. It is generally preferable to carry out such sintering by holding the compact .for a period of from 0.5 to 5 hours within a temperature range of from 950° C. to 1,200° C. When such sintering is complete, cooling may be carried out by gas quenching (cooling rate, ≥20 °C./min), controlled cooling (cooling rate, 1 to 20° C./min) or furnace cooling, the magnetic properties of the resulting R—Fe—B-type sintered magnet being similar in each case.

Following the above heat treatment for sintering, although not particularly limited, heat treatment at a lower temperature than the sintering temperature may be carried out in order to increase the H_{cJ}. This post-sintering heat treatment may be carried out as two-stage heat treatment consisting of high-temperature heat treatment and low-temperature heat treatment, or low-temperature heat treatment alone may be carried out. In such post-sintering heat treatment, the sintered body is preferably heat-treated at a temperature of between 600° C. and 950° C. in high-temperature heat treatment, and is preferably heat-treated at a temperature between 400° C. and 600° C. in low-temperature heat treatment. Cooling at this time may likewise be carried out by gas quenching (cooling rate, ≥20° C./min), controlled cooling (cooling rate, 1 to 20° C./min) or furnace cooling, R—Fe—B-type sintered magnets of similar magnetic properties being obtainable with any of these cooling methods.

The resulting R—Fe—B-type sintered magnet is machined to a predetermined shape and a slurry containing one or more type of powder selected from R¹ oxides, R² fluorides, R³ acid fluorides, R⁴ hydroxides, R⁵ carbonates and basic carbonates of R⁶ (R¹ to R⁶ being one or more selected from the rare-earth elements; these may be the same or may each be different) is coated or painted onto the magnet surfaces, after which heat treatment may be carried out in the state in which the powder has been made present on the magnet surfaces. This treatment is referred to as the grain boundary diffusion method. The grain boundary diffusion heat-treatment temperature is a temperature that is lower than the sintering temperature and preferably at least 350° C. The heat treatment time is not particularly limited, although to obtain a sintered magnet having a good structure and good magnetic properties, the heat treatment time is preferably from 5 minutes to 80 hours, and more preferably from 10 minutes to 50 hours. This grain boundary diffusion treatment causes the R¹ to R⁶ included in the powder to diffuse within the magnet, enabling an increase in the H_{cJ} to be achieved. The rare-earth elements introduced by this grain boundary diffusion are referred to above as R¹ to R⁶ for the sake of convenience. However, following gain boundary diffusion, these are all encompassed by the R constituent in the inventive magnet.

### EXAMPLES

The invention is illustrated more fully below by way of Examples and Comparative Examples, although the invention is not limited by these Examples.

### Example 1, Comparative Example 1

An alloy ribbon was produced by a strip casting process in which the raw materials were melted with a high-frequency induction furnace in an argon gas atmosphere so as to give a molten alloy containing 30.0 wt % Nd, 1.0 wt % Co, 0.9 wt % B, 0.2 wt % Al, 0.2 wt % Cu, 0.1 wt % Zr and 0.1 wt % Ga, with the balance being Fe, and the molten alloy was cooled on a water-cooled copper roll. Next, the alloy ribbon thus produced was coarsely pulverized by hydrogen decrepitation to give a coarse powder, following which 0.1 wt % of stearic acid as a lubricant was added and mixed into the coarse powder. The mixture of coarse powder and lubricant was then finely pulverized with a jet mill in a stream of nitrogen so as to give a fine powder having an average particle size of about 3.5 μm. At this time, the oxygen content was adjusted by setting the oxygen concentration within the jet mill system to 0 ppm (Example 1) and 50 ppm (Comparative Example 1). Next, the fine powder was charged, within a nitrogen atmosphere, into the mold of a powder-compacting press equipped with an electromagnet and, while being oriented in a 15 kOe (1.19 MA/m) magnetic field, was pressed in a direction perpendicular to the magnetic field. The resulting compact was sintered in a vacuum at 1,050° C. for 3 hours and then cooled to 200° C. or below, following which 2 hours of high-temperature heat treatment at 900° C. and 3 hours of low-temperature heat treatment at 500° C. were carried out, giving a sintered body. Each of the resulting sintered bodies had the following composition: Nd, 13.5 at %; Co, 1.1 at %; B, 5.5 at %, Al, 0.5 at %, Cu, 0.2 at %; Zr, 0.07 at %: Ga, 0.1 at %: C, 0.4 at %, O, see Table 1; and Fe, balance. The metallic elements were measured by inductively coupled plasma mass spectrometry (ICP-OES), the carbon was measured by the combustion-infrared absorption method, and the oxygen was measured by the inert gas fusion-infrared absorption method.

The center portion of each of the resulting sintered bodies was cut out into a rectangular parallelepiped shape having dimensions of 18 mm×15 mm×12 mm to give a sintered magnet, and the magnetic properties (Br, H_{cJ}) of each sintered magnet were measured using a B—H tracer. Table 1 shows the respective atomic percentages of B, Zr, C and O ([B], [Zr], [C], [O]) and the magnetic property (Br, H_{cJ}) values of the sintered magnets in Example 1 and Comparative Example 1. The “Effective [O] range in Example 1, Comparative Example 1” in the table refers to the range in the values of [O] that satisfy the following relationship (1′) for [B], [C], [Zr] and [O]:

0.86×([B]+[C]−2×[Zr])−4.9<[O]<0.86×([B]+[C]−2×[Zr])−4.6 (1′).

TABLE 1

| | | | | | Effective [O] | | |
|---|---|---|---|---|---|---|---|
| | | | | | range in | | |
| | | | | | Example 1, | | |
| | | | | | Comparative | | |
| | [B] | [Zr] | [C] | [O] | Example 1 | Br | H_{cJ} |
| | (at %) | (at %) | (at %) | (at %) | (at %) | (T) | (kA/m) |
| Example 1 | 5.5 | 0.07 | 0.4 | 0.22 | 0.05 to 0.35 | 1.46 | 1,130 |
| Comparative | 5.5 | 0.07 | 0.4 | 0.60 | | 1.46 | 700 |
| Example 1 | | | | | | | |

As shown in Table 1, the sintered magnet obtained in Example 1 that satisfies the condition of the invention (above relationship (1′)) has distinctly better properties in terms of H_{cJ} than the sintered magnet obtained in Comparative Example 1.

### Examples 2 to 5, Comparative Examples 2 to 6

Aside from adjusting the amounts of the metals serving as the raw materials so as to arrive at a predetermined composition, production of an alloy ribbon, hydrogen decrepitation and admixture of a lubricant with the coarse powder were carried out in the same way as in Example 1. Next, each mixture of coarse powder and lubricant was pulverized with a jet mill in a stream of nitrogen, producing a fine powder having an average particle size of about 3.5 μm. Adjustment of the oxygen content was carried out at this time by suitably adjusting the oxygen concentration within the jet milling system. The fine powder thus produced was pressed and heat-treated in the same way as in Example 1, giving a sintered body. The composition of the resulting sintered body was analyzed in the same way as in Example 1 and found to be: Nd, 13.5 at %; Co, 1.1 at %; B, see Table 2: Al, 0.5 at %; Cu, 0.2 at %; Zr, 0.07 at %; Ga, 0.1 ate ; C, 0.4 at %; 0 see Table 2; Fe, balance.

The center portion of each of the resulting sintered bodies in Examples 2 to 5 and Comparative Examples 2 to 6 was cut out into a rectangular parallelepiped shape having dimensions of 18 mm×15 mm×12 mm to give a sintered magnet, and the magnetic properties (Br, H_{cJ}) of each sintered magnet were measured using a B—H tracer. Table 2 shows the respective atomic percentages of B, Zr, C and O ([B], [Zr], [C], [O]) and the magnetic property (Br, H_{cJ}) values for each of these sintered magnets. The “Effective [O]range” in the table refers to the range in the values of [O] that satisfy the above relationship (1′) for [B], [C], [Zr] and [O].

TABLE 2

| | | | | | Effective | | |
|---|---|---|---|---|---|---|---|
| | [B] | [Zr] | [C] | [O] | [O] range | Br | H_{cJ} |
| | (at %) | (at %) | (at %) | (at %) | (at %) | (T) | (kA/m) |
| Example 2 | 5.7 | 0.07 | 0.4 | 0.27 | 0.23 to 0.53 | 1.46 | 1,060 |
| Comparative | 5.7 | 0.07 | 0.4 | 0.80 | | 1.47 | 880 |
| Example 2 | | | | | | | |
| Comparative | 5.9 | 0.07 | 0.4 | 0.31 | 0.48 to 0.78 | 1.45 | 960 |
| Example 3 | | | | | | | |
| Example 3 | 5.9 | 0.07 | 0.4 | 0.59 | | 1.46 | 1,030 |
| Comparative | 5.9 | 0.07 | 0.4 | 0.98 | | 1.47 | 900 |
| Example 4 | | | | | | | |
| Comparative | 6.1 | 0.07 | 0.4 | 0.42 | 0.57 to 0.87 | 1.45 | 990 |
| Example 5 | | | | | | | |
| Example 4 | 6.1 | 0.07 | 0.4 | 0.72 | | 1.46 | 1,050 |
| Example 5 | 6.1 | 0.07 | 0.4 | 0.81 | | 1.46 | 1,020 |
| Comparative | 6.1 | 0.07 | 0.4 | 1.10 | | 1.47 | 880 |
| Example 6 | | | | | | | |

As shown in Table 2, the sintered magnets of Examples 2 to 5 which satisfy the condition of the invention (above relationship (1′)) have higher H_{cJ} values, than the sintered magnets of Comparative Examples 2 to 6.

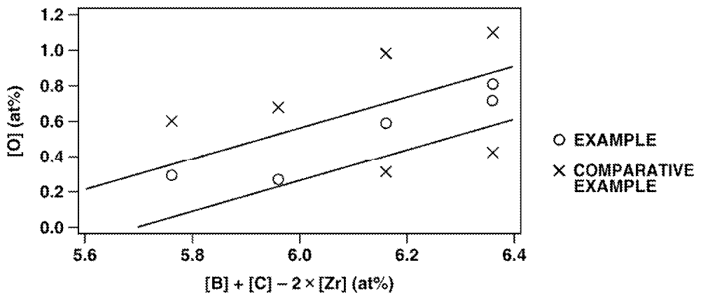

The graph in FIG. 1 shows the relationship, based on the results in Tables 1 and 2, between ([B]+[C]−2×[Zr]) and [O] for the magnets in Examples 1 to 5 and Comparative Examples 1 to 6. It is apparent from Tables 1 and 2 and FIG. 1 that, within the range where the oxygen content satisfies relationship (1′) below:

0.86×([B]+[C]−2×[Zr])−4.9<[O]<0.86×([B]+[C]−2×[Zr])−4.6 (1′),

a high Br and a high H_{cJ} of 1,000 kA/m or more are obtained. That is, sintered magnets having a suitable H_{cJ} satisfy the above relationship (1′). When the content of oxygen atoms is higher than (0.86×[B]+[C]−2×[Zr])−4.6), the abundance of the boron and carbon that contribute to formation of the R₂Fe₁₄B phase is inadequate relative to the basic composition represented as R₂Fe₁₄B and, presumably, the large decrease in H_{cJ} occurs on account of formation of the R₂Fe₁₇ phase. On the other hand, when the content of oxygen atoms is lower than (0.86×([B]+[C]−2×[Zr])−4.9), the abundance of the boron and carbon that contribute to formation of the R₂Fe₁₄B phase is excessive relative to the basic composition represented as R₂Fe₁₄B and, presumably, a different phase composed of R, Fe and B forms, lowering the H_{cJ} value. The content of oxygen atoms can be adjusted in the pulverizing step in which an alloy fine powder is obtained by pulverizing, the starting alloy.

### Examples 6 to 9

Aside from adjusting the amounts in which the metals serving as the starting materials were used to 30.0 wt % Nd, 1.0 wt % Co, 0.9 wt % B, 0.2 wt % Al, 0.2 wt % Cu, 0.1 wt % Zr and 0 to 0.3 wt % Ga with the balance being Fe, an alloy ribbon was produced in the same way as in Example 1. Next, the alloy ribbon thus produced was coarsely pulverized by hydrogen decrepitation to give a coarse powder, following which 0.1 wt % of stearic acid as a lubricant was added and mixed into the coarse powder. The mixture of coarse powder and lubricant was then finely milled with a jet mill in a stream of nitrogen so as to give a fine powder having an average particle size of about 3.5 μm. At this time, the oxygen concentration within the jet mill system was set to 0 ppm. The fine powder thus produced was then pressed and heat treated in the same way as in Example 1, giving the sintered bodies in Examples 6 to 9. The compositions of each of the resulting, sintered bodies were determined in the same way as in Example 1 and found to be: Nd, 13.5 at %; Co, 1.1 at %; B, 5.5 at %; Al, 0.5 at %; Cu, 0.2 at %; Zr, 0.07 at %; Ga, see Table 3, C, 0.4 at %; O, see Table 3; Fe, balance.

The center portion of each of the resulting sintered bodies in Examples 6 to 9 was cut out into a rectangular parallelepiped shape having dimensions of 18 mm×15 mm×12 mm to give a sintered magnet, and the magnetic properties (Br, H_{cJ}) of each sintered magnet were measured using a B—H tracer. Table 3 shows the respective atomic percentages of B, Zr, C and O ([B], [Zr], [C], [O]) and the magnetic property (Br, H_{cJ}) values for each of these sintered magnets. The measured values for the sintered magnet in Example 1 are also shown in the table. The “Effective [O] range” in the table refers to the range in the values of [O] that satisfy above relationship (1′) for [B], [C], [Zr] and [O].

TABLE 3

| | [Ga] | [B] | [Zr] | [C] | [O] | Effective [O] | Br | H_{cJ} |
|---|---|---|---|---|---|---|---|---|
| | (at %) | (at %) | (at %) | (at %) | (at %) | range (at %) | (T) | (kA/m) |
| Example 7 | 0 | 5.5 | 0.07 | 0.4 | 0.29 | 0.05 to 0.35 | 1.46 | 980 |
| Example 6 | 0.05 | 5.5 | 0.07 | 0.4 | 0.23 | | 1.46 | 1,120 |
| Example 1 | 0.10 | 5.5 | 0.07 | 0.4 | 0.22 | | 1.46 | 1,130 |
| Example 8 | 0.20 | 5.5 | 0.07 | 0.4 | 0.22 | | 1.45 | 1,110 |
| Example 9 | 0.30 | 5.5 | 0.07 | 0.4 | 0.21 | | 1.44 | 1.110 |

As shown in Table 3, the sintered magnets of Example 1 and Examples 6 to 9 which satisfy the condition of the invention (above relationship (1′)) all have good Br and H_{cJ} values. However, the sintered magnet in Example 7 which does not contain Ga has a H_{cJ} value that is somewhat inferior to those in Examples 1 and 6. Also, the Br values for the sintered magnets in Examples 8 and 9, which have Ga contents greater than 0.1 at %, are slightly lower than those in Examples 1 and 6.

1. An R—Fe—B-type sintered magnet having a composition consisting essentially of from 12.5 to 14.5 at % of R (where R is one or more element selected from the rare-earth elements, with Nd being essential), from 5.0 to 6.5 at % of B, from 0.02 to 0.5 at % of X (where X is one or more element selected from Ti, Zr, Hf, Nb, V and Ta) and from 0.1 to 1.6 at % of C, the balance being Fe, O and other, optional, elements and inadvertent impurities, wherein, letting the atomic percentages of B, C, X and O be respectively [B], [C], [X] and [O], the magnet satisfies the following relationship (1):
0.86×([B]+[C]−2×[X])−4.9<[O]<0.86×([B]+[C]−2×[X])−4.6 (1).

2. The R—Fe—B-type sintered magnet of claim 1, wherein the content of O is from 0.1 to 0.8 at %.

3. The R—Fe—B-type sintered magnet of claim 1, wherein the optional elements include from 0.1 to 3.5 at % of Co, from 0.05 to 0.5 at % of Cu, and more than 0 at % and up to 1.0 at % of Al.

4. The R—Fe—B-type sintered magnet claim 1, wherein Zr is included as X.

5. The R—Fe—B-type sintered magnet of claim 1, wherein the optional elements include more than 0 at % and up to 0.1 at % of Ga.
